(19) United States
(12) Patent Application Publication
(10) Pub. No.: US 2020/0335079 A1
(43) Pub. Date: Oct. 22, 2020

(54) DIALOGUE SYSTEM AND METHOD FOR CONTROLLING THE SAME

(71) Applicants: HYUNDAI MOTOR COMPANY, Seoul (KR); KIA MOTORS CORPORATION, Seoul (KR)

(72) Inventors: Seona KIM, Seoul (KR); Youngmin PARK, Gunpo-si (KR); Jeong-Eom LEE, Yongin-si (KR)

(73) Assignees: HYUNDAI MOTOR COMPANY, Seoul (KR); KIA MOTORS CORPORATION, Seoul (KR)

(21) Appl. No.: 16/676,800

(22) Filed: Nov. 7, 2019

(30) Foreign Application Priority Data
Apr. 19, 2019 (KR) 10-2019-0046334

(51) Int. Cl. G10L 13/033; G10L 15/22; G10L 13/047

(52) U.S. Cl. CPC G10L 13/033; G10L 2015/223; G10L 13/047; G10L 15/22

(57) ABSTRACT

Disclosed herein is a dialogue system and a method for controlling the dialogue system. In one form, a dialogue system includes a memory configured to store counterpart information for at least one counterpart; a persona generator configured to determine a user preferred characteristic based on the counterpart information and to generate a persona having the user preferred characteristic; and a dialogue processor configured to output an utterance based on the persona.

### CROSS-REFERENCE TO RELATED APPLICATION(S)

This application claims priority to and the benefit of Korean Patent Application No. 10-2019-0046334, filed on Apr. 19, 2019, the entire contents of which are incorporated herein by reference.

### FIELD

Embodiments and implementations of the present disclosure relate to a dialogue system and a method for controlling the same.

### BACKGROUND

The statements in this section merely provide background information related to the present disclosure and may not constitute prior art.

A dialogue system may recognize a user's utterance and output an utterance as a response that corresponds to the recognized user's utterance, or may provide a service necessary to the user by outputting the utterance in advance, as needed, even if the user's utterance is not input.

Since the dialogue system has a persona, which is a virtual personality given during the design of the dialogue system, the personality of the dialogue system may be reflected in generating utterances.

### SUMMARY

It is an aspect of the present disclosure to provide a dialogue system and a method for controlling the dialogue system which provide intimate and satisfactory dialogue services by generating a persona of the dialogue system reflecting a user's preference.

In one aspect of the present disclosure, a dialogue system is disclosed. One form of a dialog system may include a memory configured to store counterpart information for at least one counterpart; a persona generator configured to determine a user preferred characteristic based on the counterpart information and to generate a persona having the user preferred characteristic; and a dialogue processor configured to output an utterance based on the persona.

The memory may be further configured to store user information, and the persona generator may be configured to determine a characteristic of a user based on the user information.

The memory may be configured to store the characteristic of the user matched with the user preferred characteristic.

The memory may be configured to store each of the characteristics of a plurality of the users matched with a corresponding user preferred characteristic.

The persona generator may be configured to generate the persona having the user preferred characteristic matched with the characteristic that is the same as or similar to the determined characteristic of the user in response to a database (DB) use condition being satisfied.

The DB use condition may be satisfied when an amount of the counterpart information for at least one counterpart is less than a reference value.

The counterpart information may comprise at least one of personal information of a counterpart, search and writing history on social media, search history on a search engine, playback history of multimedia contents, e-mail, text message history, call history, dialogue history with the dialogue system or contact information.

The user information may comprise at least one of personal information of the user, search and writing history on social media, search history on a search engine, playback history of multimedia contents, e-mail, text message history, call history, dialogue history with the dialogue system or contact information.

The characteristic may comprise at least one of personality, voice, gender, tendency, values, likes and dislikes or tone.

The memory may be configured to store the counterpart information for each of a plurality of counterparts.

The persona generator may be configured to determine characteristics of each counterpart of the plurality of counterparts based on the counterpart information, and to determine the user preferred characteristic by weighting the characteristic of the counterpart preferred by the user.

The persona generator may be configured to determine the characteristic of each counterpart of the plurality of counterparts by applying a weight to information to which the user responds positively among the counterpart information.

The persona generator may comprise a characteristic learner configured to learn a characteristic of the users, and to output the characteristic of a counterpart according to a result of learning when the counterpart information is input.

The persona generator may be configured to generate the persona based on the output characteristic of the counterpart.

The characteristic learner may be configured to output the characteristic of the user according to the result of the learning when the user information is input.

The memory may be configured to store each of the characteristics of a plurality of the users matched with the corresponding user preferred characteristic.

The persona generator may be configured to generate the persona having the user preferred characteristic matched with the characteristic same as or similar to the output characteristic of the user.

The memory may be configured to store the characteristic of the user matched with the user preferred characteristic.

In another aspect of the disclosure, a method for controlling a dialogue system is disclosed. One form of a method may include determining a user preferred characteristic based on counterpart information for at least one counterpart; generating a persona having the user preferred characteristic; and outputting an utterance based on the persona.

The method may further include determining a characteristic of the user based on user information; and storing the characteristic of the user matched with the user preferred characteristic.

The method may further include determining a characteristic of the user based on user information in response to DB use information being satisfied; and searching the user preferred characteristic matched with a characteristic same as or similar to the determined characteristic of the user in a memory configured to store each of the characteristics of a plurality of the users matched with the corresponding user preferred characteristic.

Further areas of applicability will become apparent from the description provided herein. It should be understood that the description and specific examples are intended for purposes of illustration only and are not intended to limit the scope of the present disclosure.

### DRAWINGS

These and/or other aspects of the present disclosure will become apparent and more readily appreciated from the following detailed description of embodiments and implementations, taken in conjunction with the accompanying drawings of which:

FIG. 1 is a control block diagram illustrating one form of a dialogue system.

FIGS. 2 and 3 are views illustrating examples of utterances output from a dialogue system.

FIG. 4 is another control block diagram illustrating a form of a dialogue system.

FIG. 5 is another control block diagram illustrating a form of a dialogue system.

FIG. 6 is another control block diagram illustrating a form of a dialogue system.

FIG. 7 is a flowchart illustrating one form of a method for controlling a dialogue system.

FIG. 8 is a flowchart illustrating one form of a method for controlling a dialogue system, in a case where information of a counterpart is not sufficient,

The drawings described herein are for illustration purposes only and are not intended to limit the scope of the present disclosure in any way.

### DETAILED DESCRIPTION

The following description is merely exemplary in nature and is not intended to limit the present disclosure, application, or uses, It should be understood that throughout the drawings, corresponding reference numerals indicate like or corresponding parts and features.

Embodiments and implementations disclosed in the description and configurations shown in the drawings are examples of the disclosed invention. There may be various modifications that can replace the embodiments and drawings of the present description at the time of filing of the present application.

Also, the terms used herein are for the purpose of only describing particular embodiments and are not used to restrict the disclosed invention. Singular expressions include plural expressions unless there is a particular description contrary thereto, As used herein, the terms “comprise,” “include” and “have” are intended to designate that the characteristics, numbers, steps, operations, components, elements, and combinations thereof described in the description exist, not to exclude any other characteristics, numbers, steps, operations, components, elements, or combination thereof in advance.

In addition, terms such as “˜part,” “˜unit,” “˜block,” “˜member,” “˜module,” etc., may refer to a unit for processing at least one function or operation. For example, the terms may refer to at least one piece of hardware such as a field-programmable gate array (FPGA), an application specific integrated circuit (ASIC), etc., at least one piece of software stored in a memory, or at least one process which is processed by a processor.

The symbols attached to the steps are used to identify the steps. These symbols do not indicate the order between the steps. Each step is performed in an order different from the stated order unless the context clearly indicates a specific order.

Meanwhile, the disclosed embodiments and implementations may be implemented in the form of a recording medium for storing instructions executable by a computer. The instructions may be stored in the form of a program code and, when executed by a processor, may generate a program module to perform the operations of the disclosed embodiments and implementations. The recording medium may be implemented as a computer-readable recording medium.

The computer-readable recording medium may include all kinds of recording media having stored instructions thereon which can be read by a computer. For example, there may be read only memory (ROM), random access memory (RAM), a magnetic tape, a magnetic disk, a flash memory, an optical data storage device, and the like.

Hereinafter, the present disclosure will be described in detail with reference to the accompanying drawings.

A dialogue system according to some implementations is an apparatus configured to recognize a user's intention by using the users speech (i.e., utterance or verbal communication of words) and non-speech input and provide a service appropriate for the user's intention. The dialogue system may be configured to provide a service that the user needs by determining the service by itself even when there is no input from the user. The dialogue system may perform a dialogue or a conversation with the user by outputting a system utterance as a means of providing the service or a means for clarifying the intention of the user.

In some embodiments and implementations described below, the service provided to the user may include all operations performed to meet the needs of the user or the intention of the user, such as providing information, controlling an electronic product or a vehicle, and providing content obtained from an external server.

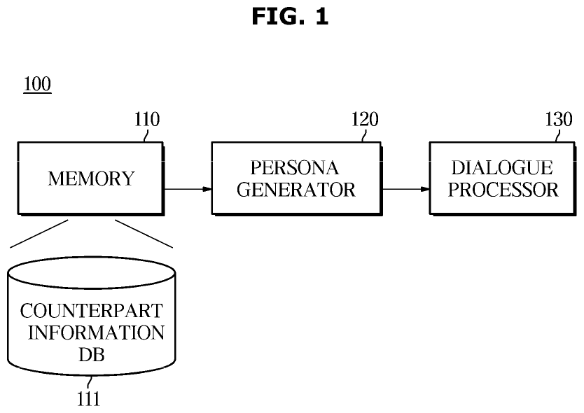

FIG. 1 is a control block diagram illustrating one form of a dialogue system.

As shown in FIG. 1, a dialogue system 100 may include a memory 110 configured to store counterpart information on at least one counterpart, a persona generator 120 configured to determine a preferred characteristic by a user based on the counterpart information and generate a persona having the determined preferred characteristic and a dialogue processor 130 configured to output a system utterance in which the generated persona is reflected.

In implementations described below, the persona may refer to a virtual person or a virtual identity given to the dialogue system 100, and may have characteristics such as personality, tendency, gender, tone, voice, likes and dislikes, value, etc. Depending on the persona of the dialogue system 100, the utterance output by the dialogue system 100 may vary.

In some implementations, the dialogue system 100 may have a persona preferred by the user. For this, it may be possible to use characteristics of the counterpart preferred by the user. Here, the counterpart preferred by the user may be a person who has the user's positive response in a telephone call, a text message, social media, or the like. The user's positive response may be confirmed by conversations between the counterpart and the user, by likes on her or his social media given from the user, or by positively commenting on the social media.

The memory 110 may store counterpart information DB 111 in which the counterpart information is stored as a database. The counterpart information may include information that represents the characteristics of the counterpart, such as contents of conversation exchanged between the user and the counterpart through a telephone call or a text message, contents of a post uploaded to the social media of the counterpart, or personal information such as age, education, occupation, gender, etc.

In addition, if it is possible to collect, the counterpart information may include at least one of search history on the social media, search history on a search engine, playback history of multimedia content, mail history, text message history or call history, conversation history with the dialogue system, and contact information.

The persona generator 120 may determine the characteristic of the counterpart based on the counterpart information. In some implementations, the characteristics of the counterpart or the user may refer to various elements forming a person such as personality, tendency, gender, voice, tone, likes and dislikes, value, and the like, and the persona of the dialogue system 100 may consist of these characteristics. Parameters such as extroversion, aggressiveness, planning, etc. may determine the characteristics.

For example, the counterpart's characteristic or the user's characteristic may be determined according to the various parameters such as whether she or he is extroverted or introverted, active or passive, planned or spontaneous, intuitive or inferential, emotional or rational, hot-tempered or gentle, whether she or he is authoritative or prefers an equal relationship, whether she or he has a strong opinion or follows other people's opinions, has leadership or followship, and whether she or he is idealistic or realistic. The parameters may further include whether the counterpart or the user prefers achievement or stability, whether she or he has a desire for knowledge or not, whether she or he prefers being alone or with people, whether she or he tends to figure out problems or avoid them, whether her or his political tendency is progressive or conservative, whether she or he speaks fast or slowly, whether she or he speaks in detail or briefly, whether she or he uses slang or standard language, whether she or he likes sports or not, what kind of sports she or he likes, etc.

As more specific examples, the counterpart's tone of speech, such as whether she or he speaks fast or slowly, whether she or he speaks in detail or briefly, whether she or he uses slang or standard language, etc., may be determined based on contents posted on the social media, contents of e-mails, contents of text messages, contents of conversations on the phone, etc.

In addition, the persona generator 120 may determine the counterpart's likes and dislikes about sports, music, movies, dramas, entertainers, food, places, etc. based on contents which are searched and posted on the social media.

Also, the persona generator 120 may analyze emotions and then reflect the emotions of the user's preferred counterpart in the persona.

In addition, the persona generator 120 may determine the characteristics of the counterpart by giving weight to the counterpart information to which the user responded positively. For example, the persona generator 120 may give weight to contents of the conversations between the user and the counterpart which has a positive response from the user or contents posted on the social media of the counterpart which as a positive response from the user. The higher the degree of the positiveness, the higher the weight.

In addition, in the case that the counterpart information for each of the plurality of counterparts is stored in the memory 110, the persona generator 120 may determine characteristics for each of the plurality of counterparts and determine the user preferred characteristic by weighting the characteristic of the counterpart preferred by the user.

For this, the persona generator 120 may determine the counterpart to which the user responds positively based on the stored counterpart information, and determine the counterpart as the counterpart preferred by the user.

In addition, it is possible to determine a preference rank for each of the counterparts according to the degree of the positiveness of the response from the user. For example, in the case that the counterpart information for three of the counterparts is stored in the memory 110, the persona generator 120 may determine the preference rank for the three counterparts based on the stored counterpart information. If the preference rank is the order of counterpart 2, counterpart 1, counterpart 3, the highest weight may be assigned to the characteristic of the counterpart 2 and the lowest weight may be assigned to the characteristic of the counterpart 3.

For example, the persona generator 120 may determine a representative value calculated by applying the above-described weight for each parameter constituting the characteristic of the counterpart as the user preferred characteristic. However, the manner in which the dialogue system 100 determines the user preferred characteristic is not limited thereto. In addition to the above-described manner, various manners used to determine one value from a plurality of values by applying a weight to a specific value may be applied to the embodiment

The persona generator 120 may generate the persona having the determined user preferred characteristic, and the dialogue processor 130 may output the utterance by reflecting the generated persona. The dialogue processor 130 may perform conversation with the user through speech recognition, natural language understanding, conversation management, and utterance generation, and may reflect the persona in the utterance generation. For example, a personality or a tone of the persona may be reflected in the output utterance.

The dialogue processor 130 may output the utterance based on the persona in response to an utterance output condition being satisfied. The case in which the utterance output condition is satisfied may include a case in which the user's utterance is input and a response to the user's utterance is required to be output, or a case in which the dialogue system 100 should output the utterance in advance in order to provide a service regardless whether the user's utterance is input.

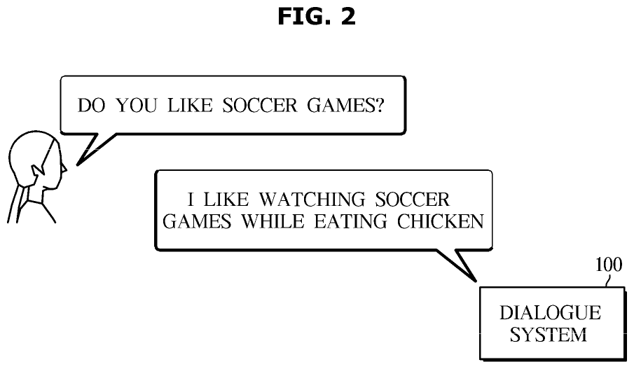

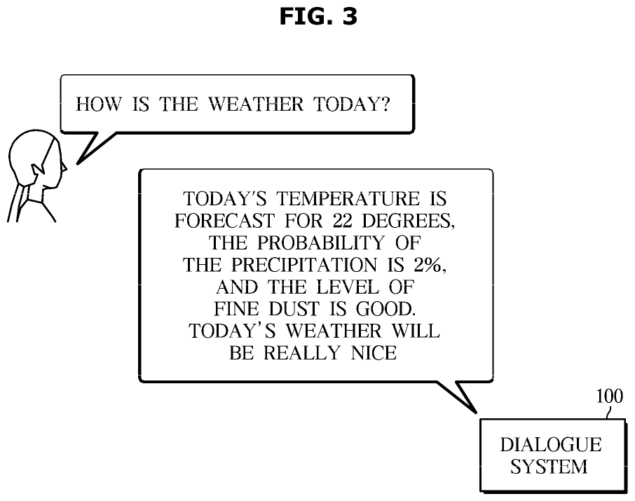

FIGS. 2 and 3 are views illustrating examples of utterances output from a dialogue system.

The dialogue processor 130 may respond to the user's question by reflecting the persona. For example, in the case that the persona likes watching soccer games and has a tendency to answer questions in detail, as shown in FIG. 2, the dialogue processor 130 may output a response, “I like watching soccer games while eating chicken” when the user asks, “Do you Ike soccer games?”

As another example, the dialogue processor 130 may output the system utterance by reflecting both the persona's tendency and tone. As shown in FIG. 3, when the user asks for today's weather, the dialogue processor 130, by reflecting the tone of the persona, may output a detailed response, “Today's temperature is forecast for 22 degrees, the probability of the precipitation is 2%, and the level of fine dust is good. Today's weather will be really nice.”

As another example, in the case that the persona has a tendency to speak quickly, when the user asks a question, the dialogue processor 130 may output the system utterance including an answer to the question quickly.

In addition, the dialogue processor 130 may output the system utterance in advance to provide the service necessary to the user even if the user's utterance is not input. The tendency and the tone of the persona may be reflected to the output system utterance.

As such, when an answer reflecting the user's preferred persona is output, the user may feel more intimate with the dialogue system 100 and may have a higher satisfaction with the service provided by the dialogue system 100.

The above-described memory 110, the persona generator 120, and the dialogue processor 130 may be provided in a server of a service provider, and may be provided in a user's terminal, which is a means providing a dialogue service, such as an electronic device including a home appliance, a smartphone, AI (Artificial Intelligence) speaker, etc. and a vehicle.

In addition, the memory 110, the persona generator 120, and the dialogue processor 130 may be provided together, and some of them may be provided in the server of the service provider and some of them may be provided in the user's terminal.

Also, part of the DB stored in the memory 110 may be stored in the user's terminal, and part of the DB may be stored in the server of the service provider.

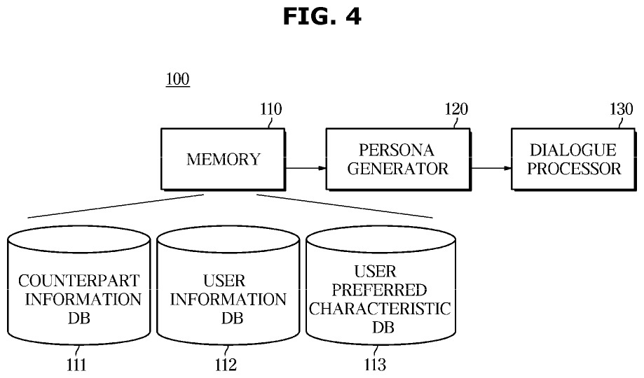

FIG. 4 is another control block diagram illustrating one form of a dialogue system.

In some implementations, the dialogue system 100 may match the user preferred characteristic determined by the persona generator 120 with the characteristic of the user and store the same in the memory 110.

As illustrated in FIG. 4, the memory 110 may include a user information DB 112 configured to store user information and a user preferred characteristic DB 113 configured to store the user's characteristic which is matched with the user preferred characteristic. Both the user information DB 112 and the user preferred characteristic DB 113 may be provided in the server of the service provider. It is also possible that the user information DB 112 is provided in the user's terminal, and the user preferred characteristic DB 113 is provided in the server of the service provider.

The persona generator 120 may determine the characteristics of the user based on the user information. The user information may include at least one of personal information such as age, education, occupation and gender, search history and posting history on social media, search history on search engines, playback history of multimedia contents, e-mail, text messages or call history, dialogue history with the dialogue system or contact information.

The persona generator 120 may determine the user's political tendency, religious tendency, and values for each issue based on the user information. For example, if the user uploaded a positive post about a particular politician on social media, the persona generator 120 may determine whether the user's political tendency is conservative or progressive according to the politician's tendency.

In addition, the persona generator 120 may determine the personality of the user based on the user information. For example, if the number of contacts of friends stored in the user's contact information is equal to or greater than a reference value or contact with friends through text messages or calls is frequent more than the reference value, the user's personality may be determined to be extrovert. In the opposite case, the user's personality may be determined to be introverted.

Alternatively, the persona generator 120 may determine the characteristic or the tendency of the user according to various parameters such as whether the user is extroverted or introverted, active or passive, planned or spontaneous, intuitive or inferential, emotional or rational, hot-tempered or gentle, whether she or he is authoritative or prefers an equal relationship, whether she or he has a strong opinion or follows other people's opinions, has leadership or followship, and whether she or he is idealistic or realistic. The parameters may further include whether the counterpart or the user prefers achievement or stability, whether she or he has a desire for knowledge or not, whether she or he prefers being alone or with people, whether she or he tends to figure out problems or avoid them, etc.

The parameters used to determine the characteristic of the user may be the same as the parameters used to determine the characteristic of the counterpart, or may be extended more than the parameters used to determine the characteristic of the counterpart when the amount of the user information is greater than the amount of the counterpart information.

The characteristics of the user determined as described above may be matched with the preferred characteristics and stored in the user preferred characteristic DB 113. The preferred characteristics matched with each characteristic of the plurality of users using the dialogue system 100 may be used to determine the characteristics that the user prefers when the counterpart information for the user is not sufficient.

As mentioned above, when the amount of information stored in the counterpart information DB 111 is not sufficient, the persona may be generated using a characteristic preferred by another user having the characteristic similar to that of the user. For this, the case in which the amount of information stored in the counterpart information DB 111 is less than the reference value is determined as a condition under which the user preferred characteristic DB 113 can be used, that is, a DB use condition, and when the condition is satisfied, the persona generator 120 may determine the characteristic of the user based on the user information and search for the preferred characteristic matched with the characteristic that is the same as or similar to that of the user.

The persona generator 120 may determine that the characteristic of the user is the same as the characteristic of another user when all of the plurality of the parameter values representing the characteristic of the user are the same as the plurality of the parameter values representing the characteristic of another user. Also, the persona generator 120 may determine that the characteristic of the user is similar to the characteristic of another user when the number of the parameter values representing the characteristic of the user, which are the same as the parameter values representing the characteristic of another user, is equal to or greater than the reference value.

As described above, when the preferred characteristic is matched with each of the user's characteristics and stored with the matched user's characteristic in the database, the user preferred characteristic may be obtained even if the counterpart information is insufficient.

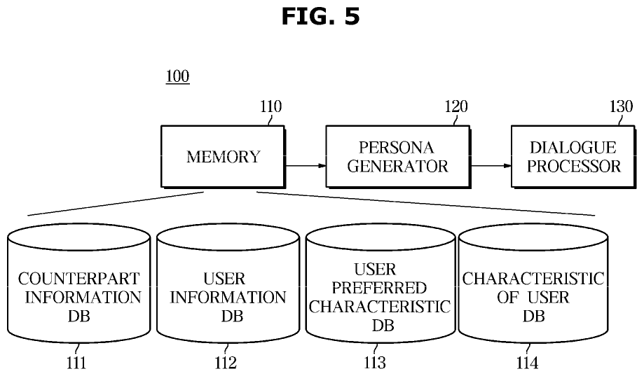

FIG. 5 is another control block diagram illustrating a dialogue system in accordance with an embodiment of the disclosure.

In some cases, there may be a lack of the user information necessary to determine the characteristic of the user. In this case, the characteristics of other users having similar personal information, search history, and the like may be referred to.

To this end, information such as personal information or search history of the other users may be matched with their characteristics and stored in the user characteristic DB 114.

When the amount of the user information is less than the reference value, the persona generator 120 may search the characteristics of the other users having similar personal information or search history in the user characteristic DB 114.

The persona generator 120 may determine the characteristic of the user using only the characteristic searched in the user characteristic DB 114, or using the searched characteristic and the characteristic determined based on the user information together, according to the amount of the user information.

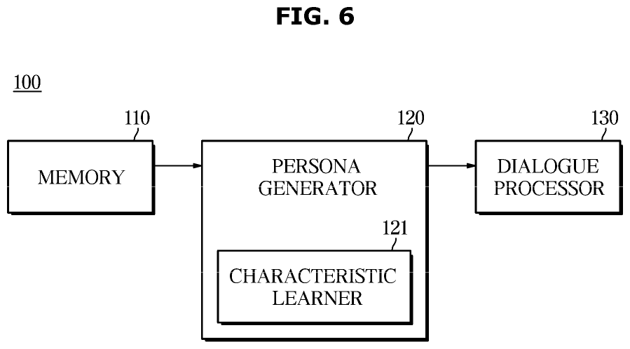

FIG. 6 is another control block diagram illustrating one form of a dialogue system.

In some implementations, the dialogue system 100 may use machine learning or deep learning to determine the characteristic of the counterpart or the characteristic of the user.

To this end, as shown in FIG. 6, a characteristic leaner 121 configured to learn the characteristic of the individual, output the characteristic of the counterpart according to the learning result when the counterpart information is input, and output the characteristic of the user according to the learning result when the user information is input may be further included in the persona generator 120.

First, personal information such as age, education, occupation, gender, etc., search and posting history on social media, search history on search engines, playback history of multimedia contents, and e-mails, text message history, call history, conversation history with the dialogue system, contact information, etc. may be collected from people of various ages, education, and occupations. Then, the individual characteristics such as personality, tendency, likes and dislikes, etc. may be determined based on a test performed on them.

The characteristic learner 121 may perform machine learning or deep learning using the collected user information and the characteristics obtained from the test as training data, and generate a characteristic determination model as a result of the learning.

After the characteristic determination model is generated, when the user information is input to the characteristic learner 121, the characteristic of a corresponding user may be output, and when the counterpart information is input, the characteristic of a corresponding counterpart may be output.

For example, in response to the DB use condition being satisfied, the persona generator 120 may input the user information into the characteristic learner 121. When the characteristic of the user is output from the characteristic learner 121, the personal generator 120 may search for the preferred characteristic matched with the characteristic same as or similar to the characteristic of the user in the memory 110 and generate the persona having the searched preferred characteristic.

Herein, if the amount of the counterpart information is less than the reference value, the DB use condition is satisfied. In the case that the DB use condition is not satisfied, the counterpart information may be input to the characteristic leaner 121. When the characteristic learner 121 outputs the characteristic of the counterpart, the persona generator 120 may determine the output characteristic of the counterpart as the user preferred characteristic and generate the persona having the user preferred characteristic.

In addition, even when the DB use condition is not satisfied, the user information may be input to the characteristic learner 121 and then the characteristic of the user may be acquired from the characteristic learner 121. The obtained characteristic of the user may be matched with the user preferred characteristic determined using the counterpart information and stored in the user preferred characteristic DB 113.

Hereinafter, a method for controlling the dialogue system will be described. In some implementations, the dialogue system 100 described above may be used to perform the method for controlling the dialogue system. Therefore, the above description regarding the dialogue system 100 may be applied to some implementations of the method for controlling the dialogue system even if there is no specific mention.

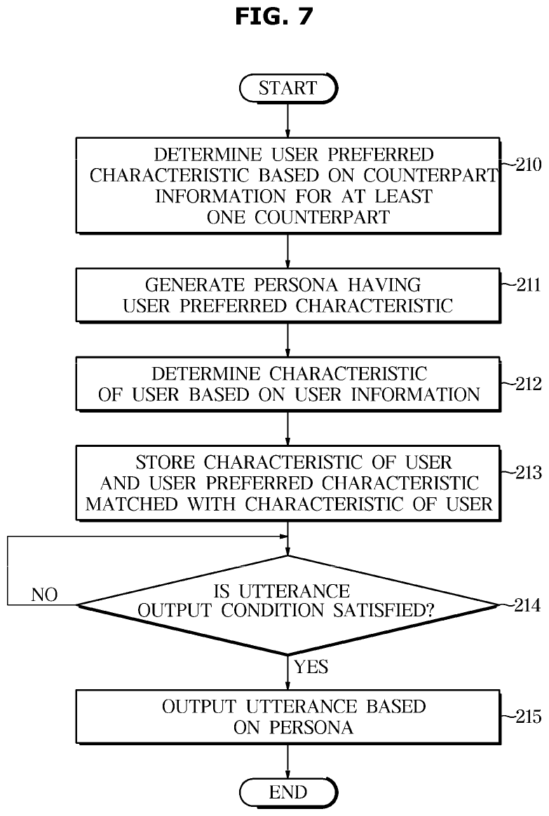

FIG. 7 is a flowchart illustrating one form of a method for controlling a dialogue system.

Referring to FIG. 7, one form of a method for controlling the dialogue system includes determining the user preferred characteristic based on counterpart information for at least one counterpart (210), and generating a persona having the user preferred characteristic (211). These steps may be performed by the persona generator 120.

The counterpart information may be stored in the memory 110, and in the case that the counterpart information for each of the plurality of counterparts is stored in the memory 110, the characteristics of each of the plurality of counterparts may be determined based on the stored counterpart information. The characteristic of the counterpart may be determined by applying a weight to the information to which the user gave a highly positive response among the counterpart information.

Alternatively, as described in implementations of the dialogue system 100, it is also possible to input the counterpart information to the characteristic learner 121 and use the characteristic of the counterpart output according to the learning result of the characteristic learner 121

In the case that the characteristics of the plurality of counterparts are obtained, the user preferred characteristic may be determined by using the user's preferences for the plurality of counterparts together with the characteristics of the plurality of counterparts. For example, the user preferred characteristic may be determined by weighting the characteristic of the counterpart preferred by the user among the plurality of counterparts.

The step to determine the user preferred characteristic based on the counterpart information is the same as described above in the embodiment of the dialogue system 100, and thus, a more detailed description thereof will be omitted.

The method for controlling the dialogue system may include determining the characteristic of the user based on the user information (212) and storing the characteristic of the user and the user preferred characteristic matched with the characteristic of the user in the memory (213). The characteristic learner 121 described above may also be used to determine the characteristic of the user.

If the characteristics of the plurality of users and their preferred characteristics are stored as a database, the database may be used to determine the preferred characteristics of the other users whose counterpart information lacks.

According some forms of the method for controlling the dialogue system, when the utterance output condition is satisfied (Yes in 214), the system utterance is output based on the generated persona (215). The case in which the utterance output condition is satisfied may include a case in which the user's utterance is input and a response to the user's utterance is required to be output, or a case in which the dialogue system 100 should output the utterance in advance in order to provide a service regardless whether the user's utterance is input. This step may be performed by the dialogue processor 130.

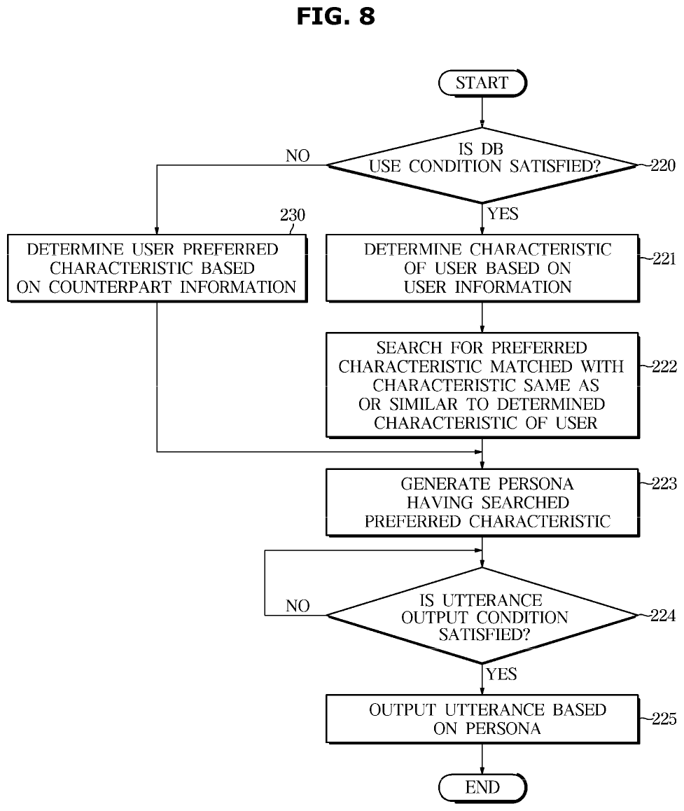

FIG. 8 is a flowchart illustrating one form of a method for controlling a dialogue system, in the case that counterpart information is not sufficient.

If the stored counterpart information is sufficient to determine the characteristic of the counterpart, as described above, the counterpart may be determined based on the counterpart information and the persona may be generated based on the characteristic of the counterpart. However, when the stored counterpart information is insufficient, the persona may be generated using the preferred characteristic of another user having the characteristic similar to the characteristic of the user.

Referring to FIG. 8, the method for controlling the dialogue system according to an embodiment may include determining whether the DB use condition is satisfied (220). The DB use condition may be satisfied when the amount of the stored counterpart information is less than the reference value.

The method for controlling the dialogue system according to an embodiment may further include determining the characteristic of the user based on the user information (221) when the DB use condition is satisfied (Yes in 220). In this case, in response to the user information being input to the characteristic learner 121, the characteristic of the user corresponding to the input user information may be output according to the result of the learning, in order to determine the characteristic of the user.

The preferred characteristics may be matched with the characteristics of a plurality of the users and stored with the matched characteristics of the plurality of users in the memory 110. Accordingly, the method for controlling the dialogue system may further include searching for the preferred characteristic matched with the characteristic same as or similar to the determined characteristic of the user (222), and generating the persona having the searched preferred characteristic (223).

The method for controlling the dialogue system may further include determining whether the utterance output condition is satisfied (224) and outputting the utterance based on the generated persona in response to the utterance output condition being satisfied (225).

When the DB use condition is not satisfied (No in 220), it means that the counterpart information is sufficient, thus according to the method for controlling the dialogue system, the user preferred characteristic may be determined based on the counterpart information for at least one counterpart (230) and the persona having the user preferred characteristic may be generated (223).

The order of the steps described in the flowcharts of FIGS. 7 and 8 is merely an example and it is also possible that each of the steps is performed in a different order according to a variation of the embodiment.

According to forms of the above-described dialogue system and the method for controlling the same, the dialogue system can provide a more friendly and satisfactory service by outputting an utterance having tendency, personality, and tone which are preferred by the user.

Embodiments and implementations of the dialogue system and the method for controlling the same have been disclosed with reference to the accompanying drawings. Those skilled in the art will understand that the present invention can be implemented in a form different from the disclosed embodiments and implementations without changing the subject matter or essential features of the present invention. The disclosed embodiments and implementations are illustrative and the scope of the present invention should not be construed as limited by the disclosed embodiments.

What is claimed is:

1. A dialogue system comprising:
a memory configured to store counterpart information for at least one counterpart;
a persona generator configured to determine a user preferred characteristic based on the counterpart information and to generate a persona having the user preferred characteristic; and
a dialogue processor configured to output an utterance based on the persona.

2. The dialogue system according to claim 1, wherein:
the memory is further configured to store user information, and
the persona generator is configured to determine a characteristic of a user based on the user information.

3. The dialogue system according to claim 2, wherein the memory is configured to store the characteristic of the user matched with the user preferred characteristic.

4. The dialogue system according to claim 2, wherein the memory is configured to store each of the characteristics of a plurality of the users matched with a corresponding user preferred characteristic.

5. The dialogue system according to claim 4, wherein the persona generator is configured to generate the persona having the user preferred characteristic matched with the characteristic that is the same as or similar to the determined characteristic of the user in response to a database (DB) use condition being satisfied.

6. The dialogue system according to claim 5, wherein the DB use condition is satisfied when an amount of the counterpart information for at least one counterpart is less than a reference value.

7. The dialogue system according to claim 2, wherein the counterpart information comprises at least one of personal information of a counterpart, search and writing history on social media, search history on a search engine, playback history of multimedia contents, e-mail, text message history, call history, dialogue history with the dialogue system or contact information and the user information comprises at least one of personal information of the user, search and writing history on social media, search history on a search engine, playback history of multimedia contents, e-mail, text message history, call history, dialogue history with the dialogue system or contact information.

8. The dialogue system according to claim 1, wherein the characteristic comprises at least one of personality, voice, gender, tendency, values, likes and dislikes or tone.

9. The dialogue system according to claim 1, wherein the memory is configured to store the counterpart information for each counterpart of a plurality of counterparts and the persona generator is configured to:
determine characteristics of each counterpart of the plurality of counterparts based on the counterpart information, and
determine the user preferred characteristic by weighting the characteristic of the counterpart preferred by the user.

10. The dialogue system according to claim 9, wherein the persona generator is configured to determine the characteristic of each counterpart of the plurality of counterparts by applying a weight to information to which the user responds positively among the counterpart information.

11. The dialogue system according to claim 1, wherein the persona generator comprises a characteristic learner configured to:
learn a characteristic of the users, and
output the characteristic of a counterpart according to a result of learning when the counterpart information is input.

12. The dialogue system according to claim 11, wherein the persona generator is configured to generate the persona based on the output characteristic of the counterpart.

13. The dialogue system according to claim 11, wherein the characteristic learner is configured to output the characteristic of the user according to the result of learning when the user information is input.

14. The dialogue system according to claim 13, wherein:
the memory is configured to store each of the characteristics of a plurality of the users matched with a corresponding user preferred characteristic, and
the persona generator is configured to generate the persona having the user preferred characteristic matched with the characteristic that is the same as or similar to the output characteristic of the user and the memory is configured to store the characteristic of the user matched with the user preferred characteristic.

15. A method for controlling a dialogue system, comprising:
determining, with a persona generator, a user preferred characteristic based on counterpart information for at least one counterpart;
generating, with the persona generator, a persona having the user preferred characteristic; and
outputting, with a dialogue processor, an utterance based on the persona.

16. The method according to claim 15, further comprising:
determining, with the persona generator, a characteristic of the user based on user information; and
storing in a memory the characteristic of the user matched with the user preferred characteristic.

17. The method according to claim 15, further comprising:
determining, with the persona generator, a characteristic of the user based on user information in response to DB use information being satisfied; and
searching the user preferred characteristic matched with a characteristic that is the same as or similar to the determined characteristic of the user in a memory configured to store each of the characteristics of a plurality of the users matched with a corresponding user preferred characteristic.

18. The method according to claim 15, wherein the determining, with a persona generator, a user preferred characteristic comprises:
determining characteristics of each counterpart of the plurality of counterparts based on the counterpart information, and
determining the user preferred characteristic by weighting the characteristic of the counterpart preferred by the user.

19. The method according to claim 15, wherein the determining, with a persona generator, a user preferred characteristic comprises:
inputting the counterpart information for at least one counterpart to a characteristic learner configured to learn a characteristic of the users; and
outputting the characteristic of a counterpart according to a result of learning.

20. The method according to claim 15, wherein the determining, with a persona generator, a user preferred characteristic comprises:
inputting user information to a characteristic learner configured to learn a characteristic of the users; and
outputting the characteristic of the user according to the result of learning.
